(19) United States
(12) Patent Application Publication
(10) Pub. No.: US 2002/0022942 A1
(43) Pub. Date: Feb. 21, 2002

(54) Apparatus and method for producing a performance evaluation model

(75) Inventor: Toshihiko Nakamura, Tokyo (JP)

Correspondence Address: Scully, Scott, Murphy & Presser, 400 Garden City Plaza, Garden City, NY, 11530, US

(73) Assignee: NEC Corporation, Tokyo (JP)

(21) Appl. No.: 09/854,159

(22) Filed: May 11, 2001

(30) Foreign Application Priority Data
May 11, 2000 (JP) 2000-138391

(51) Int. Cl. G06F 15/00; G06F 11/30

(52) U.S. Cl. 702/182

(57) ABSTRACT

The apparatus for producing a performance evaluation model of the present invention comprises a conversion rule storage unit that stores conversion rules, a UML model analysis unit that inputs and analyzes a UML model, and a conversion processing unit that produces a performance evaluation model by converting the results of analysis by the UML model analysis unit in accordance with conversion rules stored in the conversion rule storage unit.

### BACKGROUND OF THE INVENTION

1. Technical Field

The present invention relates to an apparatus for producing a performance evaluation model and a method for producing a performance evaluation model, and more particularly, to an apparatus and method for producing a performance evaluation model from a Unified Modeling Language (UML) model.

2. Background Art

It is desirable to shorten the amount of time from service analysis to realization due to increasingly short product cycles. In addition, in the field of integrated devices, systems are being required to deliver more functions and higher performance due to proliferation of data terminals, and the need has arisen for system design that intimately incorporates both hardware and software due to the appearance of system large-scale integration (LSI).

Under such circumstances, there is no hope of shortening the amount of time if evaluations are performed after deciding on system configuration and completing mounting. Therefore, it has become necessary to estimate performance and so forth during the course of determining system configuration without mounting. Performance evaluation tools using queuing theory are being used to respond to this need. In the case of such performance evaluation tools, a performance evaluation model is produced in which jobs input to a system are assigned to a processor using queuing, and performance is then evaluated by providing processing speed and other parameters. Since the cost for producing a performance evaluation model is high in the case of performance evaluation using this performance evaluation model, it has not come into widespread use even though it offers powerful performance evaluation capabilities.

A support tool for this type of performance evaluation is proposed in Japanese Unexamined Patent Application, First Publication No. Hei 7-84831 in which models used to evaluate performance in the past (performance evaluation models) are stored in a database where they are put to use in producing following design models. In the case of this tool, performance evaluation models are accumulated independent of the tool since performance evaluation is continued for a fixed period of time, thereby offering the advantage of enabling design models to be produced easily.

However, in the case of developing a system from the ground up, since it is necessary to produce a performance evaluation model from nothing when there are no similar models to the performance evaluation model, the problem is encountered in which the cost of producing the performance evaluation model is still high even if using the tool of the prior art described above.

### SUMMARY OF THE INVENTION

The object of the present invention is to provide an apparatus for producing a performance evaluation model that automatically produces a performance evaluation model from a UML model described in UML, the de facto standard language for model production.

In addition, another object of the present invention is to provide a method for producing a performance evaluation model that automatically produces a performance evaluation model from a UML model described in UML.

The apparatus for producing a performance evaluation model of a first aspect of the present invention has a conversion rule storage unit that stores conversion rules, a UML model analysis unit that inputs and analyzes a UML model, and a conversion processing unit that produces a performance evaluation model by converting the results of analysis by the UML model analysis unit in accordance with conversion rules stored in the conversion rule storage unit.

In addition, the apparatus for producing a performance evaluation model of a second aspect of the present invention has a conversion rule editing unit that inputs conversion rules from a user, a conversion rule storage unit that stores conversion rules input from the conversion rule editing unit, a UML model analysis unit that inputs and analyzes a UML model, and a conversion processing unit that produces a performance evaluation model by converting the results of analysis by the UML model analysis unit in accordance with conversion rules stored in the conversion rule storage unit.

The method for producing a performance evaluation model of the present invention comprises the steps of systematically producing a performance evaluation model from a UML model in accordance with conversion rules by defining notation for assigning to hardware resources using expanded notation of a UML model, and determining conversion rules for converting to a performance evaluation model from a UML model according to that notation.

Another method for producing a performance evaluation model of the present invention comprises the steps of setting the first message of a sequence diagram as the current message, focusing on the current message of the sequence diagram, investigating the type and attribute of a class that defines the destination object, investigating the type and attribute of a class that defines the source object, searching for conversion rules based on the types of classes that define the destination object and source object, converting and arranging the current message to the node of a performance evaluation tool in accordance with the searched conversion rules, judging whether or not there is a message following the current message, and using the next message, if present, as the current message and focusing control on that current message.

In particular, the step of investigating class type and attribute may further comprise a step of focusing on the object, a step of focusing on the class that defines the object, a step of searching for a resource correlation line that connects to said class by searching for a corresponding class from the object, a step of judging whether or not a resource correlation line exists, a step that stores the type and attribute of a resource class that correlates with the source as the class type and attribute if a resource correlation exists, and a step of storing the original type and attribute of the class as the class type and attribute if a resource correlation line does not exist.

The recording medium of the present invention records a program for enabling a computer to function as a conversion rule storage unit that stores conversion rules, a UML model analysis unit that inputs and analyzes a UML model, and a conversion processing unit that produces a performance evaluation model by converting the results of analysis by the UML model analysis unit in accordance with conversion rules stored in the conversion rule storage unit.

In addition, the recording medium of the present invention records a program for enabling a computer to function as a conversion rule editing unit that inputs conversion rules from a user, a conversion rule storage unit that stores conversion rules input from the conversion rule editing unit, a UML model analysis unit that inputs and analyzes a UML model, and a conversion processing unit that produces a performance evaluation model by converting the results of analysis by the UML model analysis unit in accordance with conversion rules stored in the conversion rule storage unit.

A first effect of the present invention is that, by producing a performance evaluation model on the basis of a UML model that is widely used in system analysis and design, production of a performance evaluation model becomes easy, and the amount of time spent on producing a performance evaluation model is shortened, thereby enabling costs to be reduced.

The reason for this is that, with respect to the portion that simply produces a function model with a UML model, conventional system design techniques can be used without modification, and a performance evaluation model can be produced based on a UML model while only taking into consideration accommodation of hardware resources.

A second effect is that it is possible to eliminate errors in the production of a performance evaluation model that can occur during production of a performance evaluation model provided there are no errors in the UML model of the system.

The reason for this is that, since there are no errors in the UML model and a performance evaluation model is systematically produced from that UML model, simple errors, misinterpretations and so forth that can occur during production of a performance evaluation model can be prevented.

A third effect is that, a wide range of existing models and models produced by others can be easily referenced regardless of differences in performance evaluation tools.

The reason for this is that, by using a uniform modeling language in the form of UML for the function model, systems can be represented using the same UML model even between different performance evaluation tools. Since performance evaluation models typically required that the model be described in a proprietary format, the models typically vary according to each tool. According to the present invention, since performance is evaluated by inputting a system function model in a uniform notation in the form of a UML model, typical tools can be used to input the system function model, enabling existing assets to be used easily regardless of differences in performance evaluation tools.

### BRIEF DESCRIPTION OF THE DRAWINGS

FIG. 1 is a block diagram showing the constitution of an apparatus for producing a performance evaluation model according to a first embodiment of the present invention.

FIG. 2 is a drawing explaining the concept of a method for producing a performance evaluation model according to a first embodiment of the present invention.

FIG. 3 is a drawing showing an example of the contents of the sequence diagram in FIG. 2.

FIG. 4 is a drawing showing an example of the contents of the class diagram in FIG. 2.

FIG. 5 indicates an example of the contents of the performance evaluation sub-model in FIG. 2.

FIG. 6 is a flow chart showing the procedure of a method for producing a performance evaluation model according to the first embodiment.

FIG. 7 is a drawing indicating an example of node group corresponding to a resource class.

FIG. 8 is a block diagram showing the constitution of an apparatus for producing a performance evaluation model according to a second embodiment of the present invention.

### BEST MODE FOR CARRYING OUT THE INVENTION

The following provides a detailed explanation of the embodiments of the present invention with reference to the drawings.

### First Embodiment

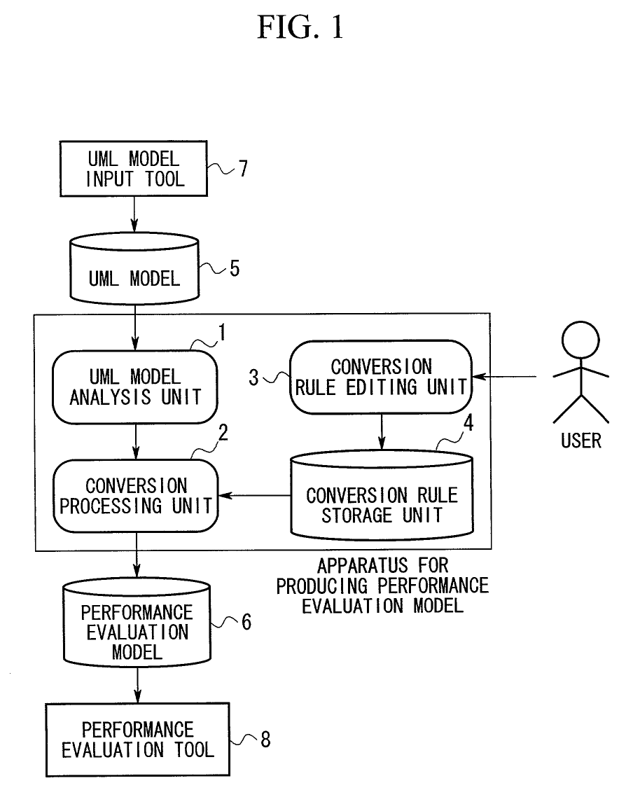

FIG. 1 is a block diagram showing the constitution of an apparatus for producing a performance evaluation model according to a first embodiment of the present invention. The apparatus for producing a performance evaluation model according to the present embodiment is composed of a UML (Unified Modeling Language) model analysis unit 1 that inputs and analyzes a UML model 5, a conversion processing unit 2 that produces a performance evaluation model 6 by converting the results of analysis by UML model analysis unit 1 in accordance with conversion rules stored in a conversion rules storage unit 4, a conversion rule editing unit 3 that inputs conversion rules from a user, and a conversion rule storage unit 4 that stores conversion rules input from conversion rule editing unit 3. Furthermore, in FIG. 1, reference symbol 7 indicates a UML model input tool that produces UML model 5, while reference symbol 8 indicates a performance evaluation tool that evaluates the performance of performance evaluation model 6.

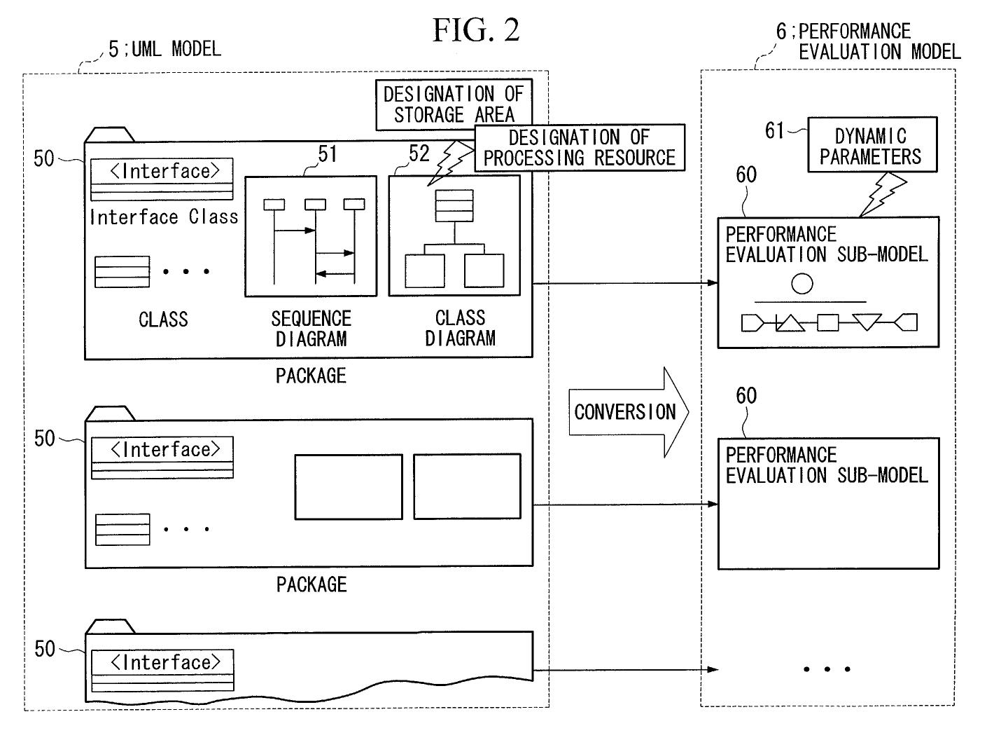

FIG. 2 is a drawing explaining a method for producing a performance evaluation model that systematically produces performance evaluation model 6 from UML model 5 in which the operation of a system is described. UML model 5 is entirely described in notation according to the standards of a uniform modeling language known as UML. System operation is represented with sequence diagram 51, which expresses dynamic behavior, and class diagram 52, which expresses the static characteristics of the system. In the first embodiment, UML model 5 is divided into units in the form of packages 50 as the description units of UML model 5. In other words, UML model 5 is composed of one or more packages 50, and a sequence diagram 51 and class diagram 52 is provided for each package 50. In addition, the units of performance evaluation model 6 produced from sequence diagram 51 and class diagram 52 in a single package 50 are referred to as performance evaluation sub-models 60. In other words, performance evaluation model 6 is composed of one or more performance evaluation sub-models 60.

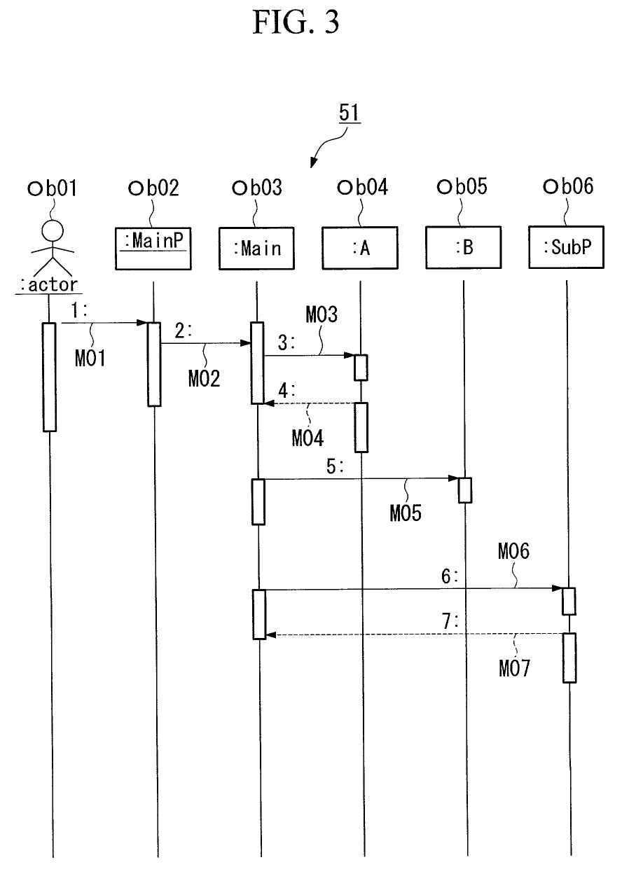

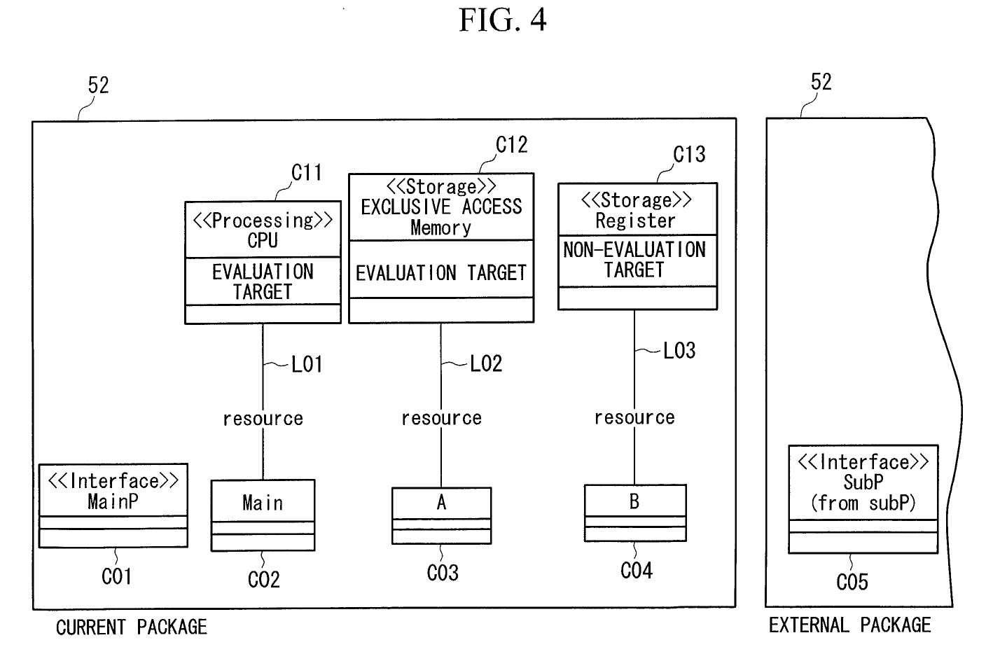

With reference to FIG. 3, sequence diagram 51 is a drawing showing a model of the system dynamic relationship. Among the constituents of sequence diagram 51, those relating to production of performance evaluation sub-models 60 consist of objects Ob01-Ob06 and messages M01-M07. Objects Ob01-Ob06 are instances of classes appearing in function units. More specifically, these are instances of classes C01-C05 corresponding to class diagram 52 of FIG. 4 to be described later. Messages M01-M07 are arranged in the actual operating order of classes C01-C05 along a time series, with those at the top representing a relatively early time. That indicated with the broken line arrow indicates a return to procedure recall. The broken line arrow of this return may be omitted.

FIG. 4 is a drawing explaining the extended notation performed to produce class diagram 52 and performance evaluation sub-model 60 for class diagram 52. Class diagram 52 is a diagram that shows the static relationship of the classes that compose the system. Classes are model elements that used for modeling, and are broadly divided into classes that compose the system normally used in object directional design (to be referred to as system classes), and classes that represent hardware resources (to be referred to as hardware classes), and each of these are additionally classified in more detail. This classification is explained in detail in the following section on “Class Classifications”. In FIG. 4, class C01-C05 are system classes. One of the extended notations added to class diagram 52 for performance evaluation is described as resource classes C11, C12 and C13 that represent hardware resources required for processing. Another extended notation is a description correlating to these hardware resources, and is named resource correlation lines L01, L02 and L03. In addition, the correlation itself is referred to as a resource correlation. By connecting system classes C02, C03 and C04 with resource classes C11, C12 and C13 using resource correlation lines L01, L02 and L03, this means that system classes C02, C03 and C04 are assigned to the hardware resources of resource classes C11, C12 and C13. This resource correlation makes it possible to produce performance evaluation sub-models 60. The conversion rules in conversion rule storage unit 4 are composed of the “Class Classifications” and “Performance Evaluation Model Conversion Rules” described below.

### Class Classifications

System Classes

Type <<Active>> Classes

These are normal classes. These classes have attributes and methods and operate independently.

Type <<Data>> Classes

In these classes, the attribute is the most important factor. The method is limited to reading and writing of the possessed attribute.

Type <<Interface>> Classes

Type <<Interface>> classes are the only classes within package 50. These classes receive all messages from external packages to the current package, and send messages to each class within the current package.

Type <<Actor>> Classes

Type <<Actor>> classes are located outside the system, and are a kind of class that performs some form of action to be taken within the system from outside. In the case an actor has a storage area within the system as well, description of the actor is required in terms of the relationship of describing class correlation as type <<Actor>> class or type <<Storage>> class in class diagram 52 (refer to “a. Actor” in the section on “Conversion Rules” described later). In all other cases, the actor need not be described in class diagram 52.

Resource Classes

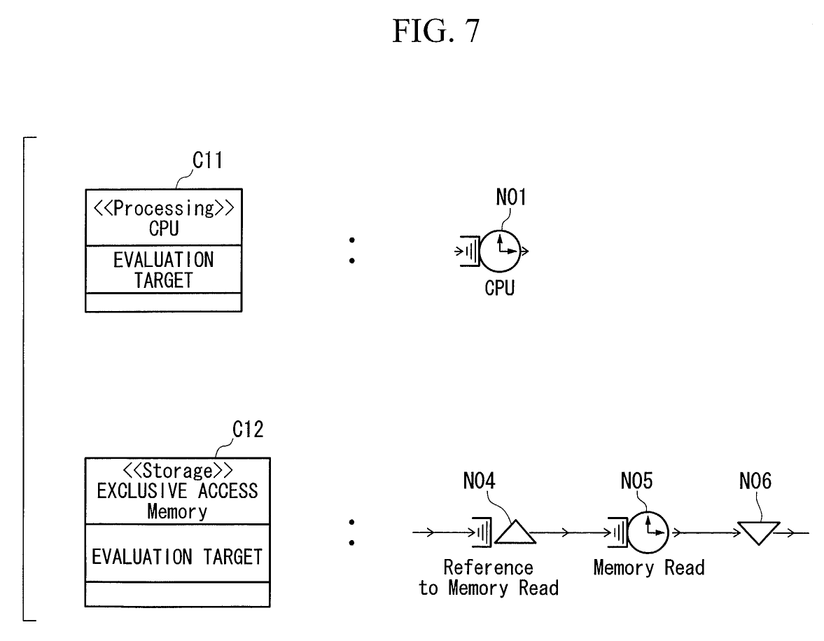

Resource classes are classes that represent hardware resources. There are node groups in resource classes that correspond to performance evaluation sub-models 60. The occupancy time of hardware resources and other parameters to be set for converted nodes are described in class attributes, and conversion is performed to the nodes of performance evaluation sub-models 60 using those parameters. When it is not required to make hardware resources a target of performance evaluation, they are described as not be applicable for evaluation, and nodes of performance evaluation sub-models 60 are not generated. An example of a node group of performance evaluation sub-models 60 to which a resource class corresponds is shown in FIG. 7.

Type <<Storage>> Classes

Type <<Storage>> classes are classes that define storage areas within hardware resources. Various classes are defined with type <<Storage>> corresponding to the type and properties of the storage area.

Type <<Processing>> Classes

Type <<Processing>> classes are classes that define hardware which actually performs processing within hardware resources. The CPU (Central Processing Unit) in the case of software processing is also defined with this class.

### Performance Evaluation Model Conversion Rules

The following conversion rules are applied corresponding to the type of class that defines the source object and destination object of a message. Conversion rules can be added by adding a class type. The following conversion rules are described with the format of “type of class that defines source object→type of class that defines destination object”.

a. “Type <<Actor>>→Arbitrary class type”

In the case a class of type <<Actor>> is the source object that sends the first message, the message is converted to a source node that is the generation source of the data.

b. “Arbitrary class type of external package→type of current package <<Interface>>”

Messages for a class of type <<Interface>> of the current package are converted to an enter node where data enters.

c. “Type <<Interface>> of current package→Arbitrary class type of external package”

Messages from a class of type <<Interface>> of the current package to an external package are converted to a return node where data exits.

d. “Arbitrary class type→Type <<Processing>>”

A resource node is arranged that defines classes of type <<Processing>>.

e. “Arbitrary class type→Type <<Storage>>”

A resource node is arranged that defines classes of type <<Storage>>.

f. “Arbitrary class type→Type <<Interface>> of an external package”

In the case a class of type <<Interface>> of an external package receives a message, since this is a request for processing to the external package, the message is converted to performance evaluation sub-model 60 corresponding to that external package. In the case the following message is in the opposite direction of the current message, the following message is ignored.

g. Broken Line Arrow Mark

Messages indicated with a broken line arrow can themselves be ignored. Accordingly, these messages can be ignored during conversion.

h. Termination Processing

In the case a synch mode or return mode is not arranged with the last message, either of these nodes is arranged to complete performance evaluation sub-model 60. Which is these nodes is arranged is determined by focusing on the first node of converted performance evaluation sub-model 60 such that a source node is arranged in the case of a synch node, while a return node is arranged in the case of an enter node.

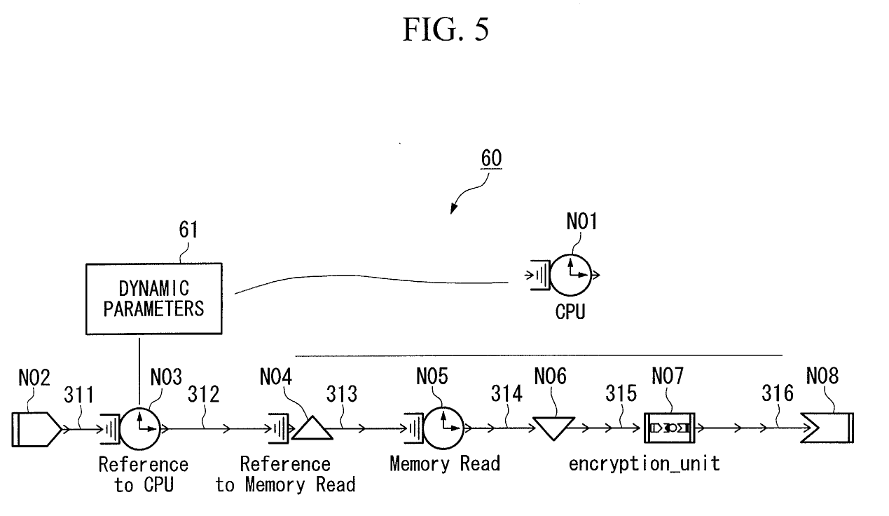

With reference to FIG. 5, performance evaluation sub-model 60 represents system configuration with nodes. These nodes can be broadly classified into nodes that represent the processing flow itself of the system, and nodes that represent hardware resources used in the processing flow. In the performance evaluation sub-model 60 in FIG. 5, the former are described on the bottom while the latter are described on the top. Nodes that represent the processing flow of the system represent that flow with connections between nodes. These nodes include service nodes that represent processing which consumes hardware, source nodes that represent data input, and synch modes that represent completion of processing. On the other hand, nodes that represent hardware resources include resource nodes corresponding to hardware. Resource nodes are consumed by processing at a service node. This consumption time, order of priority and so forth are set as dynamic parameters 61. Moreover, performance evaluation sub-model 60 can be generated by adding parameters of input data.

FIG. 5 is a drawing that describes an example of performance evaluation sub-model 60. Furthermore, an “SES/Workbench” (registered trademark of the SES Corp.) using queuing theory is assumed for performance evaluation tool 8. Service node N01 that represents the CPU is described in the upper portion of this performance evaluation sub-model 60 as a node on the processing side. On the other hand, service node N03 that consumes the CPU, service node N05 that consumes time regardless of the CPU and source node N02 and synch node N08 correlated with data input to the system as nodes representing the processing flow, sub-model node N07 that represents inquiries to performance evaluation sub-model 60, allocate node N04 for resource management, and resource node N06 as other nodes, and connections 311-316 between them are described in the lower portion of this performance evaluation sub-model 60. Finally, dynamic parameter 61 is set as notation that connects the upper portion and lower portion. During conversion, a series of nodes consisting of allocate node N04 for resource management, service node N05 that represents memory access and resource node N06 are prepared in advance as a model of exclusive access memory, and conversion rules are applied by treating these as a set. In addition to the nodes in FIG. 5, there are also an enter node and a return node that inherit the flow of data from other performance evaluation sub-models 60.

### Procedure for Converting to Performance Evaluation Sub-Model

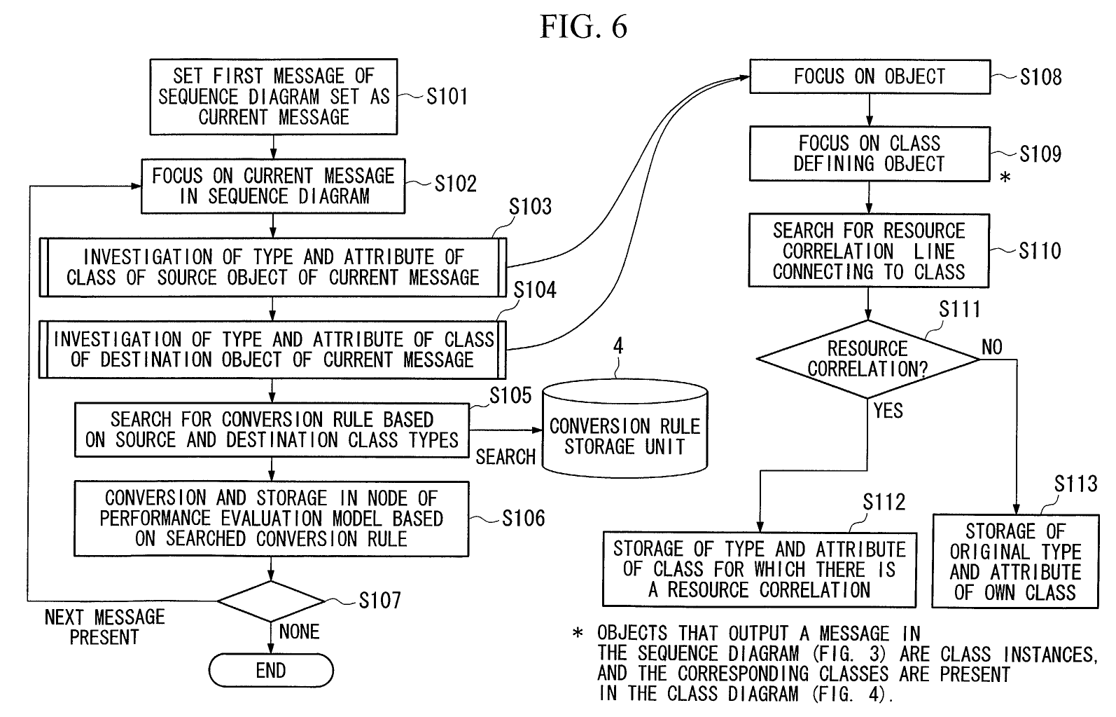

FIG. 6 is a flow chart representing the procedure for converting to performance evaluation sub-model 60. Performance evaluation sub-model 60 is generated by focusing on a certain package 50 and converting from sequence diagram 51 and class diagram 52 of that package 50. This package 50 on which attention is focused is referred to as the current package, while other packages 50 are referred to as external packages (see FIG. 4).

With reference to FIG. 6, the processing of conversion processing unit 2 is composed of current message setup step S101, current message focus step S102, source object class type and attribute investigation step S103, destination object class type and attribute investigation step S104, conversion rule search step S105, node generation and linkage step S106, next message presence judgment step S107, object focus step S108, class focus step S109, resource correlation search step S110, resource correlation presence judgment step S112, and self class type and attribute storage step S113.

Next, an explanation is provided of the operation of the apparatus for producing a performance evaluation model according to the first embodiment composed in this manner along with the method for producing the performance evaluation model according to the first embodiment.

Here, an explanation is provided for the example of converting a message from sequence diagram 51 of FIG. 3 and class diagram 52 of FIG. 4 into the performance evaluation sub-model 60 while following a time series. A user edits conversion rules in advance using conversion rule editing unit 3 and stores them in conversion rule storage unit 4. Here, the previously described conversion rules “a” through “h” are stored.

On the other hand, UML model analysis unit 1 inputs and analyzes UML model 5 that has been generated using UML model input tool 7. More specifically, a check of whether or not information not required for converting to performance evaluation sub-model 60 has been omitted and all required data is present is made, and if all required data is present, analysis results are transferred to conversion processing unit 2.

Conversion processing unit 2 sets the first message M01 of sequence diagram 51 in the analysis results transferred from UML model analysis unit 1 as the current message (Step S101).

Next, conversion processing unit 2 focuses on current message M01 of sequence diagram 51 (Step S102).

Continuing, conversion processing unit 2 investigates the type and attribute of the system class that defines source object Ob01 of current message M01 (Step S103).

More specifically, conversion processing unit 2 first focuses on source object Ob01 (Step S108), and then focuses on the class that defines source object Ob01 based on the name, “actor” (here, actor does not have a memory area in the system, and the corresponding class is not shown in FIG. 4) (Step S109). Next, a search is made for a resource correlation line that connects to that class (Step S110). Since a resource correlation line does not exist (Step S111), the original type <<Actor>> and attribute of the class are stored directly as the type and attribute (Step S113).

Next, conversion processing unit 2 investigates the type and attribute of class C01 that defines the destination object Ob01 of current message M01 (Step S104).

More specifically, conversion processing unit 2 first focuses on destination object Ob02 (Step S108), and the focuses on system class C01 that defines destination object Ob02 based on the name, “MainP” (Step S109). Next, a search is made for a resource correlation line that connects to system class C01 (Step S110). Since a resource correlation line does not exist (Step S1), the original type <<Interface>> and attribute of class C01 are stored directly as the type and attribute of system class C01 (Step S13).

Continuing, conversion processing unit 2 searches for conversion rule “a” in conversion rule storage unit 4 based on the type <<Actor>> of the class that defines source object Ob01 and the type <<Interface>> of system class C01 that defines destination object Ob02 (Step S105).

Continuing, conversion processing unit 2 converts to source node N02 based on the searched conversion rule “a” of “Convert to the data generation source in the form of a source node in the case actor is an object that sends the first message”, and arranges it in performance evaluation sub-model 60 (Step S106).

Next, conversion processing unit 2 investigates for the presence of the next message of sequence diagram 51 (Step S107), and since the next message M02 is present, it returns control to Step S102. Conversion processing unit 2 then sets message M02 as the current message and focuses on that message (Step S102).

Next, conversion processing unit 2 investigates the type and attribute of the system class that defines source object Ob02 of message M02 (Step S103). More specifically, conversion processing unit 2 first focuses on source object Ob02 (Step S108), and then focuses on system class C01 that defines source object Ob02 based on the name, “MainP” (Step S109). Next, a search is made for a resource correlation line that connects to system class C01 (Step S10). Since a resource correlation line does not exist (Step S111), the original type <<Interface>> and attribute of system class C01 are stored directly as the type and attribute of system class C01 (Step S113).

Continuing, conversion processing unit 2 investigates the type and attribute of the system class that defines destination object Ob03 of message M02 (Step S104). More specifically, conversion processing unit 2 first focuses of destination object Ob03 (Step S108), and then focuses on system class C02 that defines destination object Ob03 based on the name, “MainP” (Step S109). Next, a search is made for a resource correlation line that connects to system class C02 (Step S110). Since resource correlation line L01 exists (Step S111), the type <<Processing>> and attribute “Evaluation target” of resource class C11 for which there is a resource correlation are stored as the type of system class C02 (Step S112).

Next, conversion processing unit 2 searches for conversion rule “d” in conversion rule storage unit 4 based on the type <<Interface>> of system class C01 that defines source object Ob02, and the type <<Processing>> of system class C02 that defines destination object Ob03 (Step S105).

Continuing, conversion processing unit 2 converts to and arranges resource node N01 defined by resource class C11 of type <<Processing>> as shown in FIG. 7 by applying conversion rule “d” of “Arrange resource nodes defined by classes of type <<Processing>>.” (Step S106).

Next, conversion processing unit 2 investigates the presence of the next message of sequence diagram 51 (Step S107), and since the next message M03 is present, returns control to Step S102.

Continuing, conversion processing unit 2 sets the next message M03 as the current message and focuses on that message (Step S102).

Next, conversion processing unit 2 investigates the type and attribute of the system class that defines source object Ob03 of message M03 (Step S103).

More specifically, conversion processing unit 2 first focuses on source object Ob03 (Step S108), and then focuses on system class C02 that defines source object Ob03 based on the name, “Main” (Step S109). Next, a search is made for a resource correlation line that connects to system class C02 (Step S110). Since resource correlation line L01 exists (Step S111), the type <<Processing>> and attribute “Evaluation target” of resource class C11 for which there is a resource correlation are stored as the type and attribute of system class C02 (Step S112).

Continuing, conversion processing unit 2 investigates the type and attribute of the system class that defines destination object Ob04 of message M03 (Step S104). More specifically, conversion processing unit 2 first focuses on destination object Ob04 (Step S108), and then focuses on system class C03 that defines destination object Ob04 based on the name “A” (Step S109). Next, a search is made for a resource correlation line that connects to system class C03 (Step S110). Since resource correlation line L02 exists (Step S111), the type <<Storage>> and attribute “Non-evaluation target” of resource class C12 for which there is a resource correlation are stored as the type and attribute of system class C03 (Step S112).

Next, conversion processing unit 2 searches for conversion rule “e” in conversion rule storage unit 4 based on the type <<Processing>> of system class C02 that defines source object Ob03, and the type <<Storage>> of system class C03 that defines destination object Ob04 (Step S105).

Continuing, conversion processing unit 2 converts to resource node group N04, N05 and N06 defined by class C12 of type <<Storage>> as shown in FIG. 7 by applying conversion rule “e” of “Arrange resource nodes defined by classes of type <<Storage>>.”, and since the attribute of resource class C12 is “Evaluation target”, node group N04, N05 and N06 is arranged in performance evaluation sub-model 60 (Step S106).

Next, conversion processing unit 2 investigates the presence of the next message of sequence diagram 51 (Step S107), and although the next message M04 is present, since it is a message indicated by a broken line arrow, it is ignored after which conversion processing unit 2 investigates for the next message. Since the next message M05 is present, it returns control to Step S102. Conversion processing unit 2 then sets message M05 as the current message and focuses on that message (Step S102).

Next, conversion processing unit 2 investigates the type and attribute of the system class that defines source object Ob03 of current message M05 (Step S103).

More specifically, conversion processing unit 2 first focuses on source object Ob03 (Step S108), and then focuses on system class C02 that defines source object Ob03 based on the name, “Main” (Step S109). Next, a search is made for a resource correlation line that connects to system class C02 (Step S110). Since resource correlation line L01 is present (Step S111), the type <<Processing>> and attribute “Evaluation target” of resource class C11 for which there is a resource correlation are stored as the type and attribute of system class C02 (Step S112).

Continuing, conversion processing unit 2 investigates the type and attribute of the system class that defines destination object Ob05 of message M05 (Step S104). More specifically, conversion processing unit 2 first focuses on destination object Ob05 (Step S108), and then focuses on system class C04 that defines destination object Ob05 based on the name, “B” (Step S109). A search is made for a resource correlation line that connects to system class C04 (Step S110). Since resource correlation line L03 exists (Step S111), the type <<Storage>> and attribute “Non-evaluation target” of resource class C13 are stored as the type and attribute of system class C04 (Step S112).

Next, conversion processing unit 2 searches for conversion rule “e” in conversion rule storage unit 4 based on the type <<Processing>> of system class C02 that defines source object Ob03, and the type <<Storage>> of system class C04 that defines destination object Ob05 (Step S105).

Continuing, although conversion processing unit 2 attempts to apply conversion rule “e”, since the attribute of system class C04 is “Non-evaluation target”, conversion to a node is not performed and it is not arranged in performance evaluation sub-model 60 (Step S106).

Next, conversion processing unit 2 investigates the presence of the next message of sequence diagram 51 (Step S107), and the next message M06 is present, it returns control to Step S102.

Next, conversion processing unit 2 focuses on current message M06 of sequence diagram 51 (Step S102).

Continuing, conversion processing unit 2 investigates the type and attribute of the system class that defines source object Ob03 of current message M06 (Step S103).

More specifically, conversion processing unit 2 first focuses on source object Ob03 (Step S108), and then focuses on system class C02 that defines source object Ob03 based on the name, “Main” (Step S109). Next, a search is made for a resource correlation line that connects to system class C02 (Step S110). Since resource correlation line L01 is present (Step S111), the type <<Processing>> and attribute “Evaluation target” of resource class C11 for which there is a resource correlation are stored as the type and attribute of system class C02 (Step S112).

Next, conversion processing unit 2 investigates the type and attribute of the system class that defines destination object Ob06 of message M06 (Step S104).

More specifically, conversion processing unit 2 first focuses on destination object Ob06 (Step S108), and then focuses on system class C05 that defines destination object Ob06 based on the name, “subP” (Step S109). A search is made for a resource correlation line that connects to system class C05 (Step S110). Since a resource correlation line does not exist, (Step S111), the original type <<Interface>> and attribute of system class C05 are stored as the type and attribute of system class C05 (Step S113).

Next, conversion processing unit 2 searches for conversion rule “f” in conversion rule storage unit 4 based on the type <<Processing>> of system class C03 that defines source object Ob03, and the type <<Interface>> of system class C05 that defines destination object Ob06 (Step S105).

Continuing, conversion processing unit 2 applies conversion rule “f” and in the case a class of the type <<Interface>> of an external package receives a message, since this is a request for processing by the external package, it is converted and arranged in node N07 of performance evaluation sub-model 60 corresponding to the external package (Step S106). This node N07 represents package 50 to which system class C05 of type <<Interface>> belongs.

Next, conversion processing unit 2 investigates for the presence of the next message of sequence diagram 51, and although the next message M07 is present, since it is indicated with a broken line arrow, it is ignored after which conversion processing unit 2 investigates for the presence of the next message as a result of which, it judges that there is no message (Step S107).

Finally, conversion processing unit 2 adds termination processing to performance evaluation sub-model 60 according to conversion rule “h” since performance evaluation sub-model 60 is not completed with a single node or return mode. In this performance evaluation sub-model 60, since the first object Ob01 is used as source node N02, synch node N08 is arranged in complete performance evaluation sub-model 60.

Furthermore, although conversion rules a. through h. are stored in conversion rule storage unit 4 in the first embodiment, since conversion rules can be added to conversion rule storage unit 4 or altered by conversion rule editing unit 3, conversion can also be performed in accordance with rules other than the conversion rules indicated above.

In addition, although an explanation of a single performance evaluation sub-model 60 of package 50 has been provided in the first embodiment, the entirety of performance evaluation model 6 comprised of a plurality of performance evaluation sub-models 60 is obtained in the same manner by repeating this processing.

In the first embodiment, performance evaluation model 6 can be produced as a result of producing a UML model from a functional viewpoint of performing routine system analysis and system design, and adding resource classes that represent hardware resources and resource correlation lines that indicate correlations between system classes and resource classes. Consequently, the distance between producing UML model 5 and performance evaluation model 6 is shortened so that ultimately, the amount of time and cost of producing performance evaluation model 6 can be reduced.

### Second Embodiment

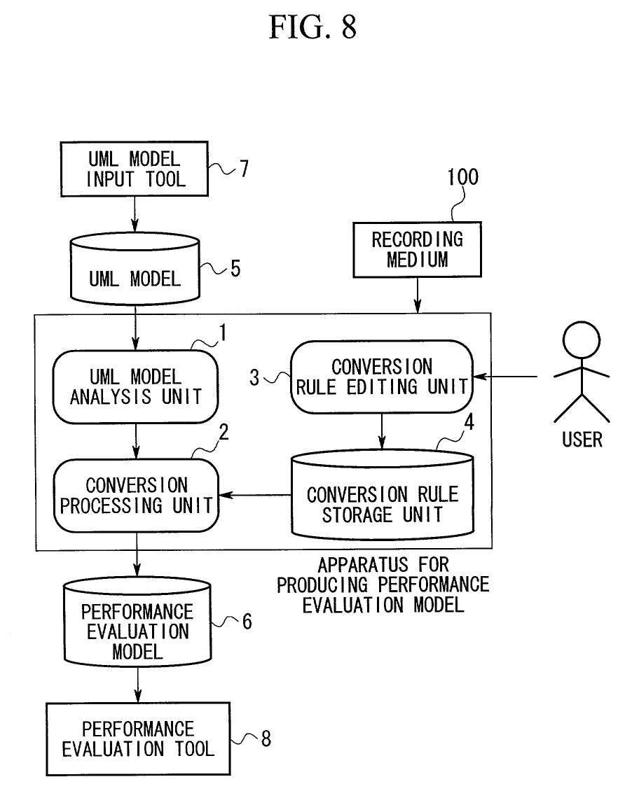

With reference to FIG. 8, the apparatus for producing a performance evaluation model according to a second embodiment of the present invention is only different from the apparatus for producing a performance evaluation model according to the first embodiment shown in FIG. 1 with respect to providing a recording medium 100 for recording a performance evaluation model production program. This recording medium 100 may be a magnetic disc, semiconductor memory or other recording medium.

The performance evaluation model production program is read from recording medium 100 into a computer in the form of an apparatus for producing a performance evaluation model, and operates as UML model analysis unit 1, conversion processing unit 2, conversion rule editing unit 3 and conversion rule storage unit 4. Since the operation of each unit 1 through 4 is completely identical to that of each corresponding unit 1 through 4 in the apparatus for producing a performance evaluation model according to the first embodiment, a detailed description of their operations is omitted.

What is claimed is:

1. An apparatus for producing a performance evaluation model, comprising:
a conversion rule storage unit that stores conversion rules,
a UML model analysis unit that inputs and analyzes a UML model, and
a conversion processing unit that produces a performance evaluation model by converting the results of analysis by the UML model analysis unit in accordance with the conversion rules stored in the conversion rule storage unit.

2. An apparatus for producing a performance evaluation model, comprising:
a conversion rule editing unit that inputs conversion rules from a user,
a conversion rule storage unit that stores conversion rules input from the conversion rule editing unit,
a UML model analysis unit that inputs and analyzes a UML model, and
a conversion processing unit that produces a performance evaluation model by converting the results of analysis by the UML model analysis unit in accordance with conversion rules stored in the conversion rule storage unit.

3. A method for producing a performance evaluation model, comprising the steps of:
defining a notation for assigning to hardware resources using expanded notation of a UML model;
determining conversion rules for converting to a performance evaluation model from a UML model according to that notation; and
systematically producing a performance evaluation model from a UML model in accordance with the conversion rules.

4. A method for producing a performance evaluation model, comprising the steps of:
setting a first message of a sequence diagram as a current message;
focusing on the current message of the sequence diagram;
investigating type and attribute of a class that defines a destination object;
investigating type and attribute of a class that defines a source object,
searching for conversion rules based on the types of classes that define the destination object and the source object;
converting and arranging the current message to the node of a performance evaluation tool in accordance with the searched conversion rules;
judging whether or not there is a message following the current message; and
using the next message, if present, as the current message and focusing control on the current message.

5. A method for producing a performance evaluation model according to claim 4, wherein the step of investigating type of class and attributes further comprises steps of:
focusing on the object;
focusing on the class that defines the object;
searching for a corresponding class from the object and searching for a resource correlation line connected to the class;
judging whether or not the resource correlation line exists;
storing the type and attribute of a resource class having a resource correlation as the type and attribute of the class if a resource correlation exists;
storing the type and attribute of the original class as the type and attribute of the class if a resource correlation line does not exist.

6. A recording medium recorded with a program for enabling a computer to function as:
a conversion rule storage unit that stores conversion rules;
a UML model analysis unit that inputs and analyzes a UML model; and
a conversion processing unit that produces a performance evaluation model by converting the results of analysis by the UML model analysis unit in accordance with conversion rules stored in the conversion rule storage unit.

7. A recording medium recorded with a program for enabling a computer to function as:
a conversion rule editing unit that inputs conversion rules from a user;
a conversion rule storage unit that stores conversion rules input from the conversion rule editing unit;
a UML model analysis unit that inputs and analyzes a UML model; and
a conversion processing unit that produces a performance evaluation model by converting the results of analysis by the UML model analysis unit in accordance with conversion rules stored in the conversion rule storage unit.
